(19) United States
(12) Patent Application Publication
(10) Pub. No.: US 2005/0036311 A1
(43) Pub. Date: Feb. 17, 2005

(54) LED light string manufacturing method

(76) Inventors: Li-Wen Liu, Hsinchu (TW); Wei-Jen Liu, Hsinchu (TW)

Correspondence Address: RABIN & BERDO, P.C., Suite 500, 1101 14th Street, N.W., Washington, DC, 20005, US

(21) Appl. No.: 10/640,265

(22) Filed: Aug. 14, 2003

(51) Int. Cl. F21V 21/00

(52) U.S. Cl. 362/249

(57) ABSTRACT

The present invention relates to the LED light string manufacturing method, wherein the two end of a plurality of wire portions are conductively connected separately with a L-shaped terminal, a row of light sockets are provided with wire holes insides, then one end of the two wire portions passes through the light socket from bottom to top, and the two terminals protrude and exposed over the surface of the light socket are manufactured into LCD, so as to form a row of LCD light string, then the plus and minus terminals on the original two ends of the LED light strings are connected correspondingly to the power supply line. Thus, achieving the effects of reducing the cost expediting the operation speed, and enhancing the safety of the electric appliance.

### BACKGROUND OF THE INVENTION

1. Field of the Invention

The present relates to a method for speeded-up manufacturing of LED light string, in particular relates to a LED light string manufacturing Method which can achieve the purpose of reducing the cost, expediting The operation speed, and enhancing the safety of the electric appliance.

2. The Prior Arts

Presently, many locations are arranged with light strings, for example, light strings are wounded around the Christmas trees, and the perimeters of the stages, so as to add to the cheerful and animated atmosphere of the occasions. Please note that, the traditional light strings use the light bulbs as the light emitting body, and matched with a power supply line with a plurality of light sockets to provide for the corresponding insertion of the light bulbs, so as to achieve a kind of concrete light string, namely obtaining a conventional product of light strings.

However, for the above light strings, since all its light bulbs are inserted into the light sockets connected in series with the power supply lines, such that each light bulb can be set upright on the power supply line. However, since the connection between each light bulb relies only on a power supply line, therefore, each light bulb can not be set upright to the same horizontal plane, so as to constitute the left or right-twisted upright state. When the light strings are applied to the locations of the stages or ladder edges, they are prone to be bent and twisted to cause trample or collision, thus causing the light bulbs damaged or broken. Besides, since the light bulbs are connected in series irregularly, resulting in that it can not achieve the orderly and aesthetical purpose in ornamentation. In addition, the power consumption of the light bulb is large, and prone to generate heat. If light bulbs are broken, they are prone to short circuit and creating safety considerations in usage.

### SUMMARY OF THE INVENTION

In view of the problems the conventional light string may create, the inventor of the present case percepts that it has not been perfected yet, therefore, basing on his many years experience accumulated in this industry, and dedicating his efforts to the related research to overcome and improve its shortcomings, so as to research and develop a new kind of improved LED light string manufacturing method, which can reduce the cost, expedite the operation speed, and enhance the safety of the electrical appliance. Therefore, the main purpose of the present invention is to design a kind of LED light string manufacturing method that can achieve the effect of reducing the cost, expediting the operation speed, and enhancing the safety of the electric appliance.

In order to achieve the above-mentioned purpose, the present invention is realized as follows: it relates to an improved LED light string manufacturing method, which is to conductively connect the two ends of a plurality of wire portions separately to the L-shaped terminals, and to provide a row of light sockets with internal wire holes, and to pass one end of the two wire portions from bottom to top through the light sockets, so as to make its two ends protrude and expose over the surfaces of the light sockets, and to process the two terminals protrude and expose over the light sockets into LEDs, thus creating a row of LED light strings, then remove the connection plates between each light socket of the LED light string, so as to straighten the wire portions originally crookedly connected between two light sockets, and to connect the positive and negative poles on the two ends of the LED light string correspondingly to the power supply line, so as to complete an orderly aligned LED light string; and as such to achieve the effect of reducing the cost, expediting the operation speed, and enhancing the safety of the electric appliance.

### BRIEF DESCRIPTION OF THE DRAWINGS

FIG. 1 is the schematic diagram of the step 1 of the present invention;

FIG. 2 is one of the schematic diagram of the step 1 of the present invention;

FIG. 3 is the schematic diagram of the step 2 of the present invention;

FIG. 4 is the schematic diagram of the step 3 of the present invention;

FIG. 5 is the schematic diagram of the step 4 of the present invention;

FIG. 6 is the schematic diagram of the step 5 of the present invention;

FIG. 7 is one of the schematic diagram of the step 5 of the present invention; and

FIG. 8 is the real embodiment diagram of the step 5 of the present invention.

### DETAILED DESCRIPTION OF THE INVENTION

In order for the Examiner to have a complete and thorough understanding of the purpose, characteristics, and functions of the present invention, the detailed explanation of the present invention is provided through the following real embodiments together with the attached drawings:

The said LED light string manufacturing method comprising the following steps:

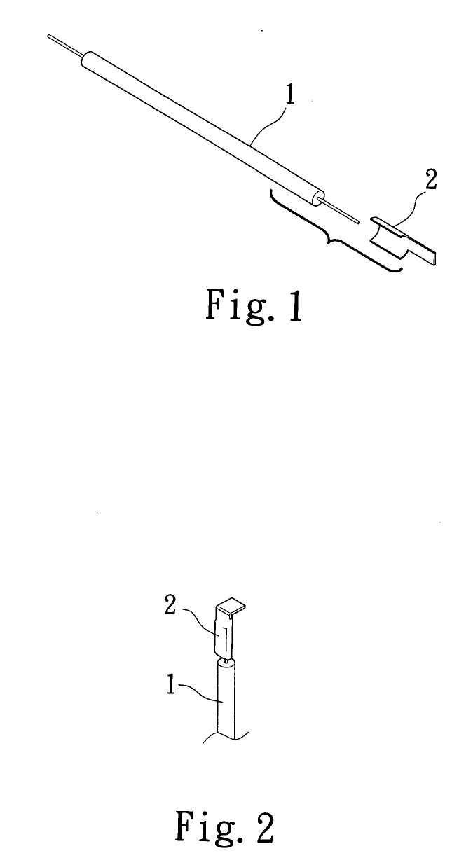

Step 1: providing a plurality of wire portions 1, and a plurality of terminals 2 which can be bent into inverse L-shape, and at least one end of two wire portions 1 each conductively connects a terminal 2, and the each two ends of the remaining wire portions 1 also conductively connect a terminal 2 separately (as shown in FIG. 1,2).

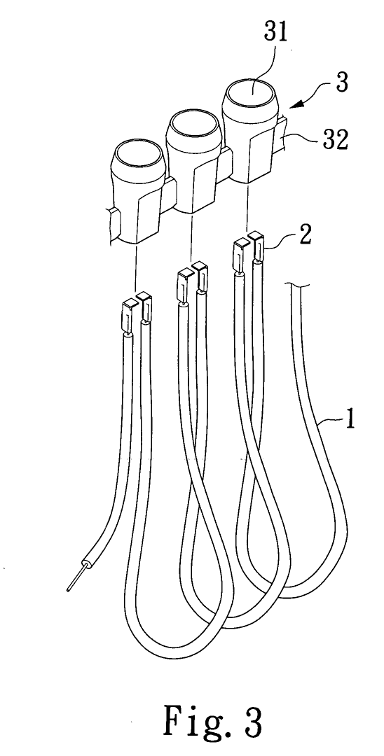

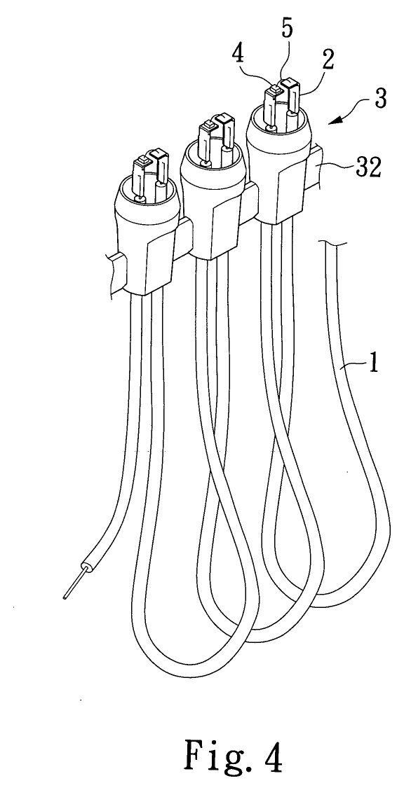

Step 2: providing a row of light sockets 3 with two wire holes 31 inside, and connection plate 32 is connected between each light socket 3. The said light socket 3 can provide a terminal 2 for each end of two wire portions 1, passing through the light socket 3 separately from bottom to top corresponding to the wire hole 31, and making the two terminals 2 protrude and expose over the surface of the light sockets 3 (as shown in FIGS. 3 & 4). In addition, the top surface of the said light socket 3 is recess-slot shaped, allowing terminal 2 to retract into the recess-slot;

Step 3: placing the LED chip 4 onto the terminal 2 of the light socket 3, and fixing it with glue, then processing it by means of microscope, connecting the positive and negative terminals of the metal wire 5 separately onto the surface of LED chip 4 and another terminal 2 (as shown in FIG. 4);

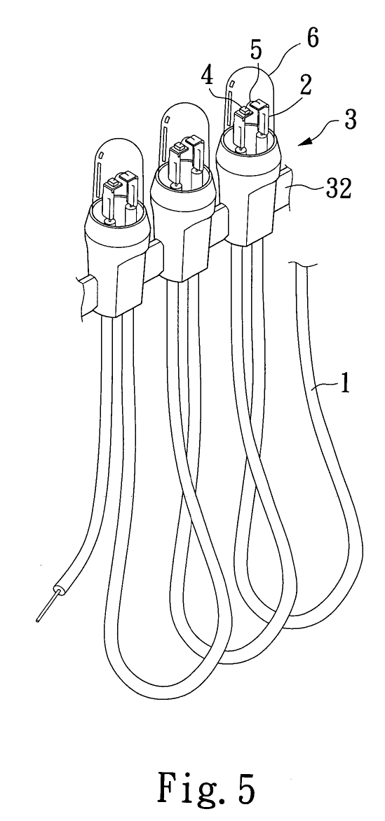

Step 4: placing a plurality of sets of light sockets 3 with two terminals 2 corresponding separately up-side-down into the molding molder, and sending it to the glue injection machine to inject glue, then putting the glue injected molding molder into the baking oven, so as to make the glue congeal into the hood body 6 of the LED chip 4, as such to form a row of LED light string (as shown in FIG. 5).

Alternatively, the glue can be injected directly into the recess slot of the light socket 2 (said glue could be resin), without going through the molding molder;

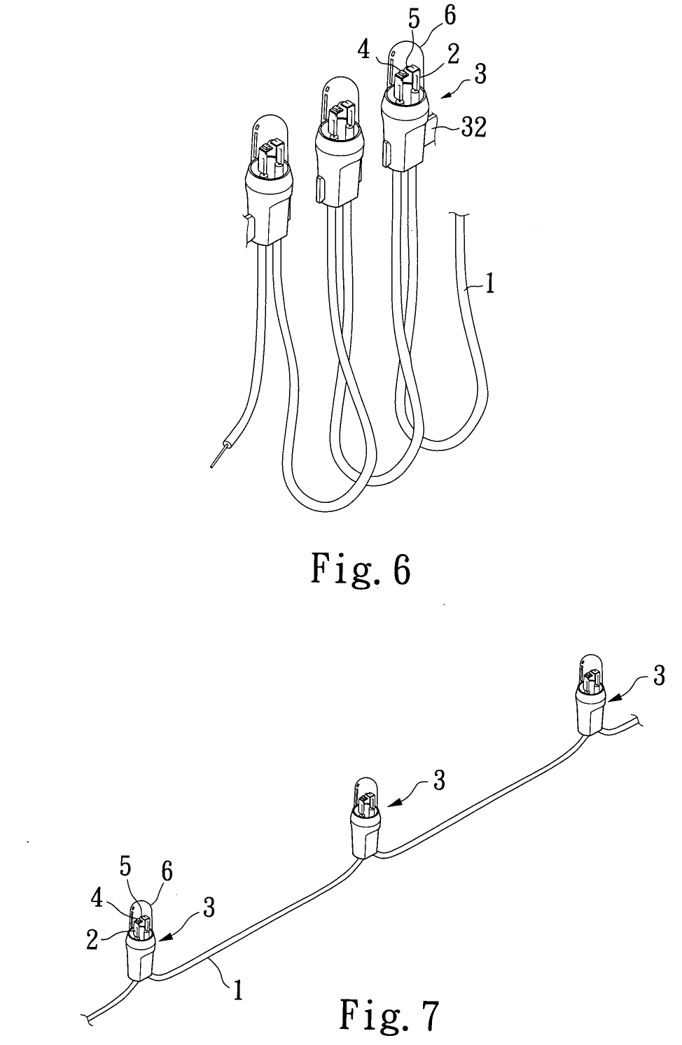

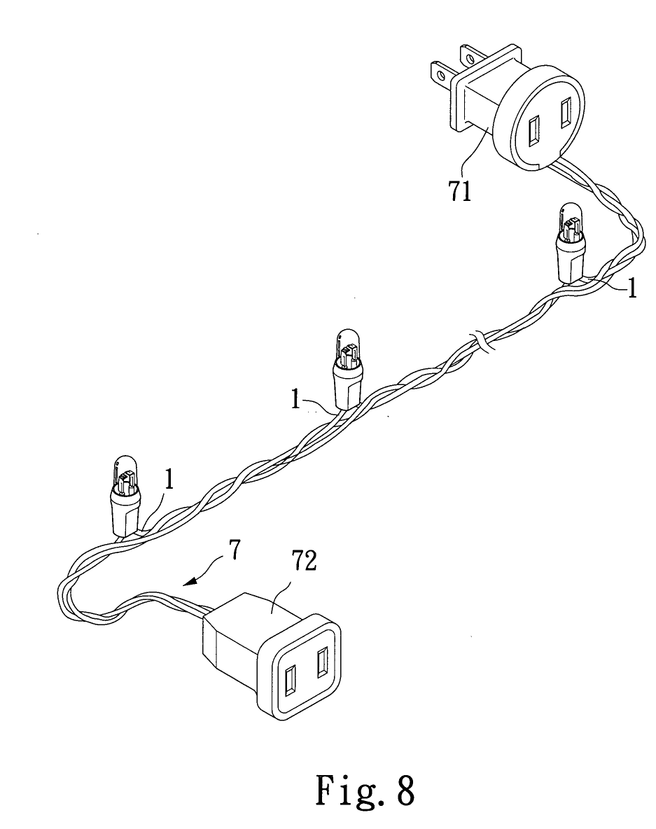

Step 5: Removing the connection plate 32 between each light socket 3 of the LED light string (as shown in FIG. 6), then straightening the connection 1 originally crookedly connected between two light sockets 3 (as shown in FIG. 7), connecting the positive and negative terminals of the two ends of the LED light string correspondingly to the power supply line 7. One end of the power supply line 7 is provided with a connector 71 containing a co-located plug/socket, and the other end is provided with a socket 72, so as to make a plurality of LED light strings connected in series or in parallel (as shown in FIG. 8).

As such, the LED light string as made by the method of the present invention, can save huge amount of waste material, by using a plurality of wire portions with terminals at two ends, which correspond separately to the wire holes inside the light socket, and processing it into the LED lamp, then removing the connection plate between each light socket, so as to make a plurality of LED, and to form its positive and negative poles in the state of connecting in series, and after injecting glue it can carry on testing. If during testing malfunction does not occur in the LED light strings, then it can proceed to connect the LED light string to the power supply line or the power source core wire, then it can complete the product of the LED light string, and meanwhile, it can save the tedious work of testing the light sockets one by one. As such, it can achieve the effect of reducing the material loss, simplifying the manufacturing steps, reducing the cost, expediting the operation speed, and enhancing the safety of the electrical appliance.

Though the present invention is disclosed in relation to the preferred embodiment as above, but it is not intended to restrict the scope of the present invention. To those familiar with the this art, some variations and modifications can be made without departing from the spirit and scope of the present invention, and all the equivalent changes and modifications made according to the present invention should be covered by the scope of patent of the present invention, and its definition should be based on the claims.

1. A LED light string manufacturing method, and it is characterized in that it comprises the following steps:
providing a plurality of wire portions with their two ends each conductively connecting a terminal, and a plurality of light sockets arranged in rows with holes inside,
making one end of the two wire portions to pass the light sockets separately from bottom to top, so as to make the two terminals protrude and expose over the surface of the light socket, and then
putting the LED chip onto a terminal inside the light socket, and fixing it with glue;
connecting the two ends of the metal wire separately onto LED chip surface and another terminal;
putting a plurality of groups of light sockets conductively connecting in string into the glue injection machine for injecting the glue, and sending them into the baking oven after finishing injecting the glue, thus making the glue congeal into the hood body of the LED chip, so as to form a row of LED light string, and finally removing the connection plate between each light socket of the LED light string, and then straightening the wire portion originally crookedly connected between two light sockets, so as to make the positive and negative poles of the two ends of the LED light string connected corresponding to the power supply line.

2. The LED light string manufacturing method according to claim 1, wherein the said terminal is of the inverted L shape.

3. The LED light string manufacturing method according to claim 1, wherein there exist two wire holes inside the light socket, providing the terminal on one end of the two wire portions to pass through it correspondingly.

4. The LED light string manufacturing method according to claim 1, wherein the epoxy is directly injected into the top surface of the light socket, to form integrally with the said light socket into the hood body, and the said epoxy resin is the above-mentioned glue.

5. The LED light string manufacturing method according to claim 1, wherein the epoxy resin on the light socket is formed at a upper end with recess.

6. The LED light string manufacturing method according to claim 4, wherein the epoxy resin on the light socket is formed at a upper end with recess.
